(19) United States
(12) Patent Application Publication
(10) Pub. No.: US 2023/0238825 A1
(43) Pub. Date: Jul. 27, 2023

(54) APPARATUS FOR AND METHOD OF WIRELESS POWER TRANSFER

(71) Applicant: THE UNIVERSITY OF LIVERPOOL, Liverpool Merseyside (GB)

(72) Inventors: Jiafeng ZHOU, Liverpool Merseyside (GB); Yuan ZHUANG, Liverpool Merseyside (GB); Chen XU, Liverpool Merseyside (GB); Yi HUANG, Liverpool Merseyside (GB)

(73) Assignee: THE UNIVERSITY OF LIVERPOOL, Liverpool Merseyside (GB)

(21) Appl. No.: 17/769,370

(22) PCT Filed: Oct. 5, 2020
(86) PCT No.: PCT/GB2020/052457

§ 371 Date: Apr. 15, 2022

(30) Foreign Application Priority Data
Oct. 17, 2019 (GB) 1915064.8

(51) Int. Cl. H02J 50/00; H02J 50/10

(52) U.S. Cl. CPC H02J 50/005; H02J 50/10

(57) ABSTRACT

A transmitter for inductive charging of a device comprising a receiver is provided. The transmitter includes a set of coils, including a first coil having a first turn and a second turn. The first turn and the second turn are adjacent. The first turn has the first sense and the second turn has the second sense, opposed to the first sense; whereby, in use, current flows through the first turn and the second turn in opposed senses.

### CROSS-REFERENCE TO RELATED APPLICATIONS

The present application is a national phase entry of PCT Application No. PCT/GB2020/052457, filed Oct. 5, 2020, which claims the benefit of priority of Great Britain Application No. 1915064.8, filed Oct. 17, 2019, the entire contents of which are hereby incorporated by reference in their entirety for all purposes.

### FIELD

The present invention relates to wireless power transfer.

### BACKGROUND

Wireless power transfer (WPT) (also known as wireless power transmission, wireless energy transmission (WET) and electromagnetic power transfer) is the transfer of electrical energy without wires as a physical link. In a WPT system (also known as a network), a transmitter (also known as a Tx), driven by electric power from a power source, generates a time-varying electromagnetic field, which transmits power across space to a receiver (also known as a Rx), which extracts electrical power from the generated electromagnetic field and supplies the extracted electrical power to an electrical load. WPT can eliminate use of wires and/or batteries, thus increasing mobility, convenience, and safety of a device including a receiver.

Generally, WPT techniques fall into two categories: near-field and far-field. In near-field (also known as non-radiative) techniques, power is transferred over relatively short distances by magnetic fields using inductive coupling between coils of wire, or by electric fields using capacitive coupling between metal electrodes. Inductive coupling is the most widely used WPT, having applications including charging handheld devices such as smartphones and electric toothbrushes, RFID tags, induction cooking, and wirelessly charging or continuous wireless power transfer of implantable medical devices such artificial cardiac pacemakers, or electric vehicles. In far-field (also known as radiative techniques and power beaming) power is transferred by beams of electromagnetic radiation, for example microwaves or laser beams. These far-field techniques can transport power over relatively longer distances but must be targeted at the receiver. Proposed applications of far-field techniques are for solar power satellites, and wireless powered drone aircraft.

Wireless power transfer systems using coupled magnetic resonances are susceptible to the transfer position variation between the transmitter (Tx) and receiver (Rx). This is mainly due to that the coupling between Tx and Rx is highly position-dependent. Once the transfer position deviates from the optimum one, the coupling will be either excessive or weak which results in power transfer efficiency (PTE) degradation.

Hence, there is a need to improve wireless power transfer.

### BRIEF SUMMARY

It is one aim of the present invention, amongst others, to provide an apparatus for and a method of wireless transfer which at least partially obviates or mitigates at least some of the disadvantages of the prior art, whether identified herein or elsewhere. For instance, it is an aim of embodiments of the invention to provide a transmitter having reduced position-dependency. For instance, it is an aim of embodiments of the invention to provide a network comprising such a transmitter and a receiver having improved coupling. For instance, it is an aim of embodiments of the invention to provide a method of inductive charging having improved power transfer efficiency.

A first aspect provides a transmitter for inductive charging of a device comprising a receiver, wherein the transmitter comprises:

a set of coils, preferably planar coils, including a first coil and optionally a second coil, comprising a first turn and a second turn;

wherein the first turn and the second turn are adjacent; and

wherein the first turn has a first sense and the second turn has a second sense, opposed to the first sense;

whereby, in use, current flows through the first turn and the second turn in opposed senses.

A second aspect provides an array, preferably a planar array, comprising a set of transmitters, including a first transmitter according the first aspect.

A third aspect provides a network comprising a transmitter according to the first aspect and a receiver comprising a coil, preferably wherein the transmitter and the receiver are inductively coupled resonators.

A fourth aspect provides a method of inductive charging of a device comprising a receiver using a transmitter according to the first aspect.

### BRIEF DESCRIPTION OF THE SEVERAL VIEWS OF THE DRAWINGS

For a better understanding of the invention, and to show how exemplary embodiments of the same may be brought into effect, reference will be made, by way of example only, to the accompanying diagrammatic Figures, in which:

FIG. 1 shows an equivalent circuit of a typical two-coil MRC-WPT system;

FIG. 2 shows a typical relationship among S₂₁, mutual inductance and resonant frequency;

FIG. 3 shows (a) a multi-turn circular coil; (b) a set of single-turn filament coils; and (c) simplified single-turn filamentary Tx/Rx coil configuration;

FIG. 4 shows mutual inductance and S21 against the variation of (a) transfer distance, (b) horizontal misalignment for different Tx coils;

FIG. 5 shows (a) mutual inductance variation with the transfer distance of different Tx sizes with the same Rx; (b) Tx and Rx configuration; (c) ideal case of mutual inductance variation against the transfer position of coils with different sizes;

FIG. 6 shows Tx and Rx structures (a) exemplary bi-directional Tx; (b) conventional unidirectional Tx; (c) unidirectional Rx;

FIG. 7 shows an optimised flat mutual inductance against the position variation of (a) transfer distance; and (b) horizontal misalignment of an exemplary embodiment of Tx structure;

FIG. 8 shows a photograph of measurement setup;

FIG. 9 shows Measured S₂₁ against frequency with the variation of h of (a) Type-I; (b) Type-II; and (c) an exemplary embodiment;

FIG. 10 shows a comparison of the measured PTE of an exemplary embodiment with conventional designs against (a) transfer distance (d=0 mm); and (b) horizontal misalignment (h=40 mm);

FIG. 11 shows measured PTE performance against the horizontal misalignment with different transfer distances;

FIG. 12 shows measured PTE performance with the transfer position variation with a reference efficiency of 70%;

FIG. 13 shows a transmitter according to an exemplary embodiment;

FIG. 14 shows a transmitter according to an exemplary embodiment; and

FIG. 15 shows a transmitter according to an exemplary embodiment.

### DETAILED DESCRIPTION

According to the present invention there is provided a transmitter, as set forth in the appended claims. Also provided are an array, a network and a method. Other features of the invention will be apparent from the dependent claims, and the description that follows.

Transmitter

The first aspect provides a transmitter for inductive charging of a device comprising a receiver, wherein the transmitter comprises:

a set of coils, preferably planar coils, including a first coil and optionally a second coil, comprising a first turn and a second turn;

wherein the first turn and the second turn are adjacent; and

wherein the first turn has a first sense and the second turn has a second sense, opposed to the first sense;

whereby, in use, current flows through the first turn and the second turn in opposed senses.

In other words, the first turn and the second turn are bi-directional such that wireless power transfer is range-adaptive, based on differential coupling using one or more (i.e. multiple) bi-directional coils. That is, the first turn and the second turn such the net coupling between the receiver and the first turn and the second turn is substantially more constant over a broader range of transfer distances and/or misalignments (i.e. transfer positions), compared with a conventional transmitter. Hence, a power transfer efficiency (PTE) is relatively more constant as a function of transfer position such that inductive charging is more robust with respect to changes in the transfer positions. In this way, performance of the network is much less sensitive to the transfer position, demonstrating a great potential in wireless charging applications.

Wireless power transfer (WPT) systems via strongly coupled magnetic resonances (CMR) have shown a breakthrough in high-efficiency WPT applications. However, the resonant condition is a critical requirement of achieving maximum power transfer efficiency (PTE) between the transmitter (Tx) and receiver (Rx). The resonant condition of a given CMR-WPT system is usually fixed regarding the transfer position. Once the transfer position of the system varies from the optimum one, the PTE of the system will decrease significantly. Herein, the “distance” is defined as the space between the two planes where the Tx and Rx are located. The “horizontal misalignment” refers to the displacement of the centre points of the Tx and Rx along the parallel planes. A shorter transfer distance (h) between Tx and Rx would cause over-coupling where the excessive coupling will split the resonant frequency. It weakens the power transfer at the original resonant frequency. A larger transfer distance or horizontal misalignment (d) would reduce the coupling, leading to impedance mismatch which will degrade the PTE. Many applications such as the charging of biomedical bioelectronic device, electric vehicles and mobile electronics would require the flexibility of the transfer position and a high PTE simultaneously. Ideally, WPT systems should have a high PTE regardless of the transfer position variation.

Recently, many methods have been presented to address this issue such as adaptive frequency tracking impedance control circuit, metamaterial and switching coils with different transfer distances. However, the added control or switching circuits will significantly increase the complexity of the system and reduce the overall system operating efficiency. An antiparallel resonant loop structure has been proposed to eliminate the frequency splitting by weakening the excessive coupling caused by the short transfer distance. However, the maximum PTE will only be achieved at an optimal transfer distance, and the anti-misalignment ability was not discussed. The multiple-input and multiple-output concept may be used with a multi-transmitter array system. A nonlinear parity-time-symmetric circuit has been applied to achieve robust WPT and range-adaptive performance has been achieved. However, active circuits are needed, and the resonant frequency was adaptively changed to maintain high PTE. This can be a great limitation for WPT applications. A reconfigurable system is used to further increase PTE in conforming to charging device positions. However, very few passive solutions have been reported for a WPT system to achieve high PTE under both transfer distance variation and horizontal misalignment conditions simultaneously. Thus, how to design high-efficiency range-adaptive WPT systems without active control is still very challenging.

The first aspect provides a new method for solving this problem, in which a planar Tx structure with multiple bi-directional sub-coils maintains a resonant condition of the CMR-WPT system. Included herein are theory and experimental demonstration that the Tx structure achieves a relatively constant mutual inductance between Tx and Rx over a broad range of transfer distance and misalignment variation without the need for any impedance tracking or active control circuits. The design concept is described, and a robust mathematical model is established for the optimization of the structure.

Theoretical Analysis

A. Two-Coil MRC-WPT Operating Principle

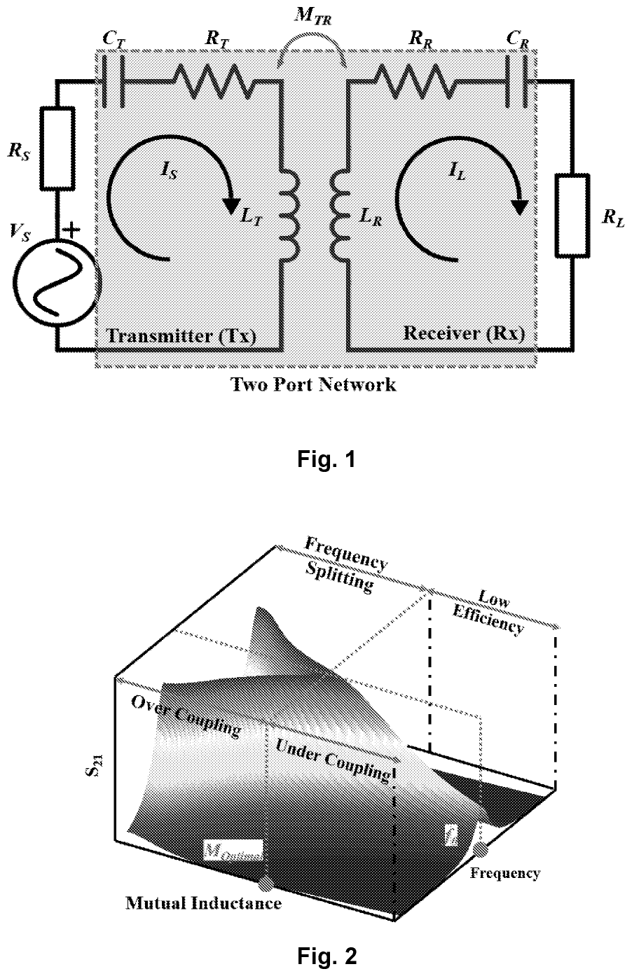

An equivalent circuit of a typical two-coil CMR-WPT system (i.e. a network comprising a transmitter and a receiver) is depicted in FIG. 1. R_{S}, R_{L}, L_{T}, L_{R}, R_{T}, R_{R}, C_{T}, C_{R}, and M_{TR} are the source resistance, load resistance, coils' self-inductance, coils' radiative and ohmic losses, resonating capacitor and mutual inductance of the Tx and Rx respectively. For simplicity, assume a lossless case, R_{T}=R_{R}=0Ω. The ratio of the received power on the load P_{L} and the input power P_{S}, namely PTE, is given by Equation 1:

$$η = \frac{{P}_{L}}{{R}_{S}} = {\vert {S}_{21} \vert}^{2} \times 100 \%$$

The node equations of the circuit based on Kirchhoff's voltage law can be built using Equation 2:

$$( {R}_{S} + j ω {L}_{T} + \frac{1}{j ω {C}_{T}} ) {I}_{S} - j ω {M}_{TR} {I}_{L} = {V}_{S}$$

and Equation 3:

$$( {R}_{L} + j ω {L}_{R} + \frac{1}{j ω {C}_{R}} ) {I}_{L} - j ω {M}_{TR} {I}_{S} = 0$$

where ω is the angular frequency of the system in rad/s. Combining Equations 2 and 3, the current flowing through Rx can be obtained by Equation 4:

$${I}_{L} = \frac{j ω {M}_{TR} {V}_{S}}{{ω}^{2} {M}_{TR}^{2} + ( j ω {L}_{T} + \frac{1}{j ω {C}_{T}} + {R}_{S} ) \cdot ( j ω {L}_{R} + \frac{1}{j ω {C}_{R}} + {R}_{L} )}$$

Then the S₂₁ can be derived by Equation 5:

$$\begin{matrix}{S}_{21} = 2 \frac{{V}_{L}}{{V}_{S}} \sqrt{\frac{{R}_{S}}{{R}_{L}}} \\ = 2 \frac{{I}_{L} {R}_{L}}{{V}_{S}} \sqrt{\frac{{R}_{S}}{{R}_{L}}} \\ = \frac{2 j ω {M}_{TR} \sqrt{{R}_{S} {R}_{L}}}{{M}_{TR}^{2} {ω}^{2} + ( j ω {L}_{T} + \frac{1}{j ω {C}_{T}} + {R}_{S} ) \cdot ( j ω {L}_{R} + \frac{1}{j ω {C}_{R}} + {R}_{L} )}\end{matrix}$$

If the circuit is operating at the resonant frequency ω₀ on both Tx and Rx side, then according to Equation 6:

$${ω}_{0} = \frac{1}{\sqrt{{L}_{T} {C}_{T}}} = \frac{1}{\sqrt{{L}_{R} {C}_{R}}}$$

then, Equation 5 can be simplified thus to Equation 7:

$${S}_{21} = \frac{2 j {ω}_{0} {M}_{TR} \sqrt{{R}_{S} {R}_{L}}}{{M}_{TR}^{2} {ω}_{0}^{2} + {R}_{S} {R}_{L}}$$

It can be observed from Equation 7 that the power transferred to the load is dependent on the magnitude of the mutual inductance (coupling condition) between the Tx and Rx. To achieve the maximum PTE (for lossless condition S₂₁=1), an optimal mutual inductance should be adopted critically to achieve the highest efficiency (Equation 8):

$${M}_{Optimal} = \frac{\sqrt{{R}_{S} {R}_{L}}}{{ω}_{0}}$$

For a given source/load termination impedance, the relationship between S₂₁, the mutual inductance and the frequency can be plotted as shown in FIG. 2. The maximum efficiency operation at the desired resonating frequency f₀ can only be achieved when the mutual inductance is M_{Optimal}. When the system is operating at over coupling conditions, the resonating frequency will be split into two. The magnitude of S₂₁ at the desired frequency will be degraded significantly due to the excessive coupling between Tx and Rx. On the other hand, when the system is working at under coupling conditions, the desired resonant frequency will be maintained but the PTE will drop dramatically due to the weak coupling. Hence, to transfer power with the maximum S₂₁ at the desired resonating frequency, the mutual inductance must be maintained at M_{Optimal}.

B. Transfer Position and Mutual Inductance

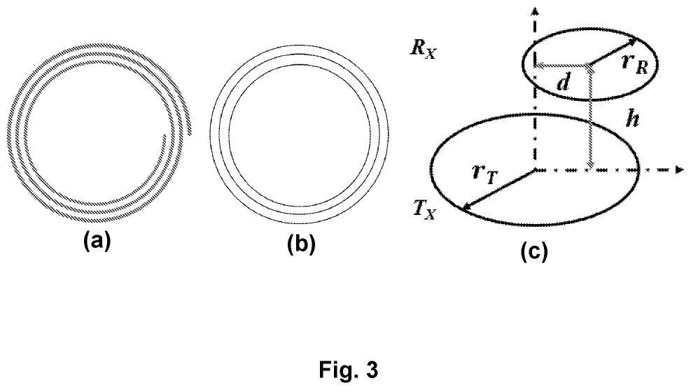

The Tx and Rx of the MRC-WPT can be realized by using multi-turn circular coils connected in series with a capacitor to resonate. To calculate the mutual inductance between the Tx and Rx, a multi-turn coil can be simplified to a set of concentric single-turn coils. Every single turn can be further simplified to a filamentary coil as shown in FIG. 3.

FIG. 3(a) shows a typical multi-turn circular coil. When calculating couplings, the multi-turn coil can be treated as a set of single-turn filament coils as shown in FIG. 3(b). The coupling between each turn of coils in the Tx and each turn in the in Rx can be calculated using the simplified single-turn filamentary Tx/Rx coil configuration shown in FIG. 3(c).

N_{T}, N_{R}, r_{Ti} and r_{Rj} denote the number of turns, and radius of each single-turn coil for the Tx and Rx, respectively. The mutual inductance Mᵢⱼ between the i^{th} single-turn Tx coil and j^{th} single-turn Rx coil can be expressed as a function of h and d, by Equation 9:

$${M}_{ij} ( {r}_{Ti} , {r}_{Rj} , h , d ) = \frac{{μ}_{0} \sqrt{{r}_{Ti} {r}_{Rj}}}{2 π} {\int }_{0}^{2 π} \frac{1 - \frac{d}{{r}_{Rj}} cos ( ϕ )}{ζ} Λ ( k ) d ϕ$$

where the parameters in Equation 9 can be expressed as:

$$ζ = {( 1 + \frac{{d}^{2}}{{r}_{Rj}^{2}} - \frac{d}{{r}_{Rj}} )}^{\frac{3}{4}} \qquad Equation 10$$

$$Λ ( k ) = ( \frac{2}{k} - k ) K ( k ) - \frac{2}{k} E ( k ) \qquad Equation 11$$

$$k = \sqrt{\frac{4 {αζ}^{\frac{3}{4}}}{{( 1 + {αζ}^{\frac{3}{4}} )}^{2} + {β}^{2}}} \qquad Equation 12$$

$$α = \frac{{r}_{Rj}}{{r}_{Ti}} , β = \frac{h}{{r}_{Ti}} \qquad Equation 13$$

where μ₀=4π×10⁻⁷ H/m is the magnetic constant, K(k) and E(k) are the complete elliptic integrals of the first and second kind, respectively. The total mutual inductance between Tx and Rx with the number of the turns N_{T} and N_{R} can be calculated from Equation 14:

$${M}_{Tr} = {\sum }_{j = 1}^{{N}_{R}} {\sum }_{i = 1}^{{N}_{T}} {M}_{ij} ( {r}_{Ti} , {r}_{Rj} , h , d )$$

Herein, for a given two-coil MRC-WPT system, there exists one set of values of h and d with which the system can achieve an optimum mutual inductance M_{TR}=M_{Optimal}, yielding the maximum S₂₁ at the desired frequency. Variation in either the h or d is likely to degrade S₂₁.

Differential Coupling Design

A. Smooth Mutual Inductance Against Transfer Position

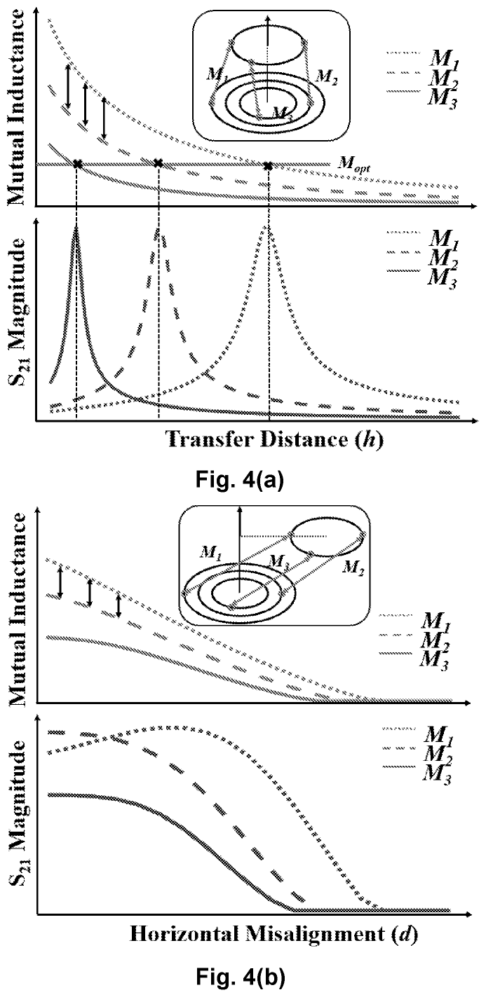

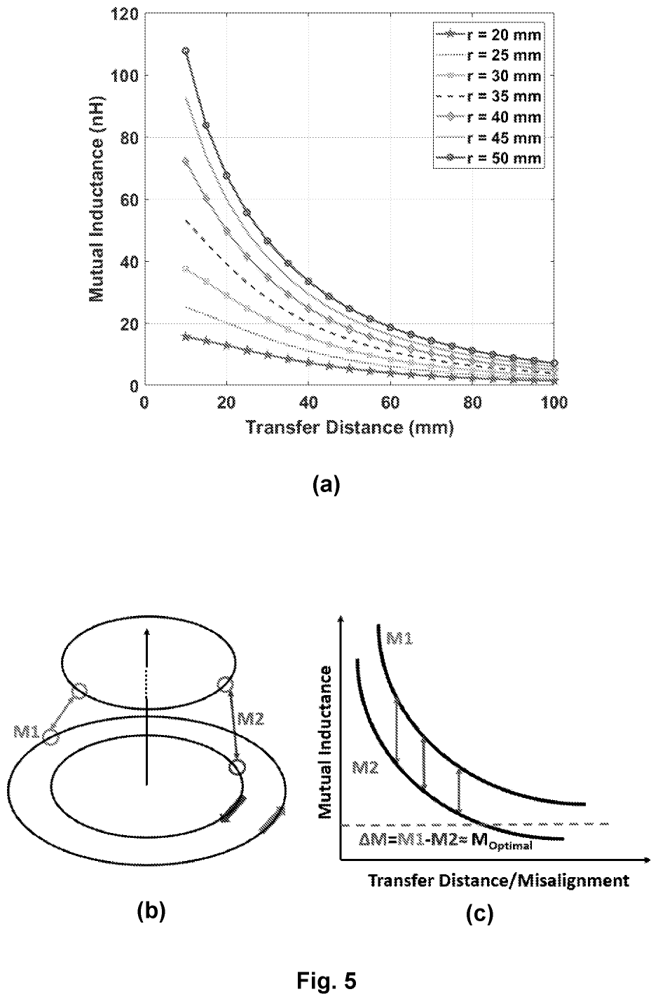

By combining Equation 7 and Equation 14, the relationship between S₂₁ and the transfer position including both h and d can be obtained as shown in FIG. 4. It can be observed that when Tx coils with different sizes are coupled with the same Rx coil, the mutual inductance will generally decrease with the increase of either h or d. For any Tx size, there exists one set of h and d where the maximum S₂₁ can be achieved.

For example, the mutual inductance between a Tx and an Rx can be calculated using Equation 14. The mutual inductance of a single-turn Tx of different sizes as a function of h is illustrated in FIG. 5(a). Although the magnitudes of the mutual inductances of different Tx are not identical, they follow a similar degradation trend. If the currents fed into two coils of different sizes are of opposite directions as shown in FIG. 5(b), the total mutual inductance Mₜₒₜₐₗ can be depicted in FIG. 5(c). The mutual inductance between each sub-coil in the Tx and the Rx decreases with the increase of the transfer distance or misalignment.

The sub-coils in a Tx according to an exemplary embodiment have two opposite directions. The sub-coils in the Tx of the clockwise direction and the Rx have an overall mutual inductance M_{clockwise}. The sub-coils in the Tx of the anti-clockwise direction and the Rx have an overall mutual inductance M_{anti-clock}. The total mutual inductance Mₜₒₜₐₗ will be the difference of M_{clockwise} and M_{anti-clock}. Although both M_{clockwise} and M_{anti-clock} will decrease with the increase of the transfer distance or misalignment, by properly designing the sub-coils, Mₜₒₜₐₗ can be maintained relatively constant. An Mₜₒₜₐₗ that is robust against the transfer position can be realized. Mₜₒₜₐₗ can be optimized to approach M_{Optimal} to achieve the desired coupling condition.

B. Bi-Directional Coil Analysis and Design

For coupled resonators in a filter, there exist two types of couplings: electrical coupling and magnetic coupling. The two couplings can be either weakening or strengthening each other, depending on the construction of the resonators. When the couplings are cancelling each other, it has been shown in a previous work that the overall coupling coefficient can be kept constant over a very wide range of distances. The magnitude of the overall coupling can be controlled by choosing proper dimensions for the resonators The main difference of the of the first aspect is that herein only one type of coupling (magnetic), but of different senses, is needed. It eliminates the potential eddy current loss associated with metal parts which are needed for strong electric coupling.

Once the optimal mutual inductance of the system is obtained by Equation 8, the task resides in realising the desired mutual inductance by choosing a proper coil size, the number of sub-coils, the number of turns in each sub-coil for the Tx, and the current direction in each sub-coil. To ensure that current can flow in both directions, the Tx sub-coils are oriented in a bi-directional manner. The coils on the Rx are unidirectional. In the practical design, the Tx may consist of X sub-coils. Each sub-coil has N_{T}; turns with an average radius of r_{Ti}. The X sub-coils are connected in series with adjacent sub-coils wound in opposite directions as shown in FIG. 5(a). Four sub-coils are used in this design (X=4). A capacitor is connected to the coil to form a resonator. The total mutual inductance between the Tx and Rx of an exemplary embodiment can be calculated from Equation 15:

$${M}_{total} = {\sum }_{n = 1}^{N} {\sum }_{j = 1}^{{N}_{R}} {\sum }_{i = 1}^{{N}_{Tn}} {( - 1 )}^{n - 1} {M}_{ij} ( {r}_{Ti} , {r}_{Rj} , h , d )$$

The calculation of the total mutual inductance can be simplified by central approximation which uses the average coil size to represent each loop in the same sub-coil. Herein, Equation 15 can be approximated as Equation 16:

$${M}_{total} \approx {\sum }_{n = 1}^{X} {( - 1 )}^{n - 1} {N}_{R} {N}_{Tn} {M}_{n} ( {r}_{Tn} , {r}_{R} , h , d )$$

where Mₙ represents the mutual inductance between the n^{th} sub-coil in the Tx and the Rx. The turn number of the Rx coil is fixed herein, for convenience, but is not limited thereto. The initial parameters of the turns are chosen empirically based on the desired transfer range and size requirement of the application. The flatness of the mutual inductance against the transfer position can be obtained by optimising the number of turns in every sub-coil of the Tx. Other parameters, such as the width of each turn or the gap between adjacent turns, can also be taken into account for optimization if necessary. A differentiation-based method was used for the optimization. Because the slope of the mutual inductance curve against the transfer distance and misalignment are not identical, the optimisation process against misalignment was carried out separately. If the total mutual inductance Mₜₒₜₐₗ changes slowly against the transfer distance h, the gradient of Mₜₒₜₐₗ against h should be very small, ideally close to zero. Assuming that the desired transfer distance is in the interval [h₁, h₂], Y samples are selected in the interval [h₁, h₂]. At the m^{th} sample hₘ, it is desired to achieve Equation 17:

$${\sum }_{n = 1}^{X} {( - 1 )}^{n - 1} {N}_{R} {N}_{Tn} \frac{{dM}_{n} ( h )}{dh} {\vert}_{h = {h}_{m}} = 0$$

On the other hand, assume that the transfer distance h is constant and now the total mutual inductance Mₜₒₜₐₗ (d) changes slowly against misalignment d, the differentiation of regards d should be close to zero. Thus, the differentiation of the mutual inductance regards d at the q^{th} sample d_{q} in the desired misalignment range [d₁, d₂] should satisfy Equation 18:

$${\sum }_{n = 1}^{X} {( - 1 )}^{n - 1} {N}_{R} {N}_{Tn} \frac{{dM}_{n} ( h )}{dd} {\vert}_{d = {d}_{q}} = 0$$

For Y samples in the interval [h₁, h₂], a matrix can be constructed based on Equation 17, particularly as given by Equation 19:

M̅H̅Ū=0

where Ū is a vector consisting of the number of loops for every Tx coil and M̅H̅ is a matrix with element in row m and column n given by Equation 20:

$${M}_{m , n} = {( - 1 )}^{n - 1} {N}_{R} \frac{{dM}_{n} ( h )}{dh} {\vert}_{h = {h}_{m}}$$

The optimization of the mutual inductance against misalignment in the interval of [d₁, d₂] can be carried out similarly. For misalignment optimisation, M̅D̅ is a matrix whose element in row q and column n can be expressed by Equation 21:

$${M}_{m , n} = {( - 1 )}^{n - 1} {N}_{R} \frac{{dM}_{n} ( h )}{dd} {\vert}_{d = {d}_{q}}$$

Now, the optimal loops number for each sub-coil can be found by solving Equation 22:

$$[ \begin{matrix}{N}_{R} \frac{{dM}_{1} ( h )}{dh} {\vert}_{h = {h}_{1}} & … & {( - 1 )}^{n - 1} {N}_{R} \frac{{dM}_{n} ( h )}{dd} {\vert}_{h = {h}_{1}} \\ ⋮ & ⋱ & ⋮ \\ {N}_{R} \frac{{dM}_{1} ( h )}{dh} {\vert}_{h = {h}_{m}} & … & {( - 1 )}^{n - 1} {N}_{R} \frac{{dM}_{n} ( h )}{dh} {\vert}_{h = {h}_{m}}\end{matrix} ] [ \begin{matrix}{N}_{T 1} \\ ⋮ \\ {N}_{Tn}\end{matrix} ] = [ \begin{matrix}0 \\ ⋮ \\ 0\end{matrix} ]$$

$$[ \begin{matrix}{N}_{R} \frac{{dM}_{1} ( h )}{dd} {\vert}_{d = {d}_{1}} & … & {( - 1 )}^{n - 1} {N}_{R} \frac{{dM}_{n} ( d )}{dd} {\vert}_{d = {d}_{1}} \\ ⋮ & ⋱ & ⋮ \\ {N}_{R} \frac{{dM}_{1} ( h )}{dd} {\vert}_{d = {d}_{q}} & … & {( - 1 )}^{n - 1} {N}_{R} \frac{{dM}_{n} ( d )}{dd} {\vert}_{d = {d}_{q}}\end{matrix} ] [ \begin{matrix}{N}_{T 1} \\ ⋮ \\ {N}_{Tn}\end{matrix} ] = [ \begin{matrix}0 \\ ⋮ \\ 0\end{matrix} ]$$

$${\sum }_{n = 1}^{X} {( - 1 )}^{n - 1} {N}_{R} {N}_{Tn} {M}_{n} ( {r}_{Tn} , {r}_{R} , h , d ) = {M}_{Optimal}$$

Finally, the optimal solution can be obtained for the system to achieve the desired mutual inductance for the desired range [h₁, h₂] and [d₁, d₂].

C. Numerical Calculation

A prototype was designed for evaluation. The desired optimal range for transfer distance and misalignment are set to be h₁=10 mm, h₂=50 mm and d₁=0 mm, d₂=50 mm respectively. The number of samples used in Equation 15 is 5 for both the transfer distance and misalignment. The parameters obtained by calculation using Equations 15 to 22 are shown in Table 1.

TABLE 1
Design parameters. N_{T1}, N_{T2}, N_{T3}, N_{T4}, correspond with 1A, 11B, 11C, 11D, respectively.
N_{T} designates transmitter and N_{R} designates receiver.
Design Parameters

| | | | | | | |
|---|---|---|---|---|---|---|
| Coil | Number of | | | | | |
| (i.e. | loops (i.e. | Average | Self- | | | |
| set of | number of | radius | Inductance | Capacitor | Unloaded | |
| turns) | turns) | (mm) | (μH) | (pF) | Q | Direction |

Herein

| | | | | | | |
|---|---|---|---|---|---|---|
| N_{T1} | 5.2 | 84.6 | 20.9 | 11.7 | 127 | Clockwise |
| N_{T2} | 4.2 | 67.7 | | | | Anti- |
| | | | | | | clockwise |
| N_{T3} | 1.8 | 45.1 | | | | Clockwise |
| N_{T4} | 2.2 | 33.9 | | | | Anti- |
| | | | | | | clockwise |
| N_{R} | 14 | 45.1 | 55.6 | 4.4 | 65 | Clockwise |

Type I

| | | | | | | |
|---|---|---|---|---|---|---|
| N_{T} | 5 | 45.1 | 7.1 | 34.3 | 47 | NA |
| N_{R} | 5 | 45.1 | 7.1 | 34.3 | 47 | NA |

Type II

| | | | | | | |
|---|---|---|---|---|---|---|
| N_{T} | 5 | 84.6 | 19.8 | 12.3 | 43 | NA |
| N_{R} | 4 | 45.1 | 4.5 | 53.6 | 45 | NA |

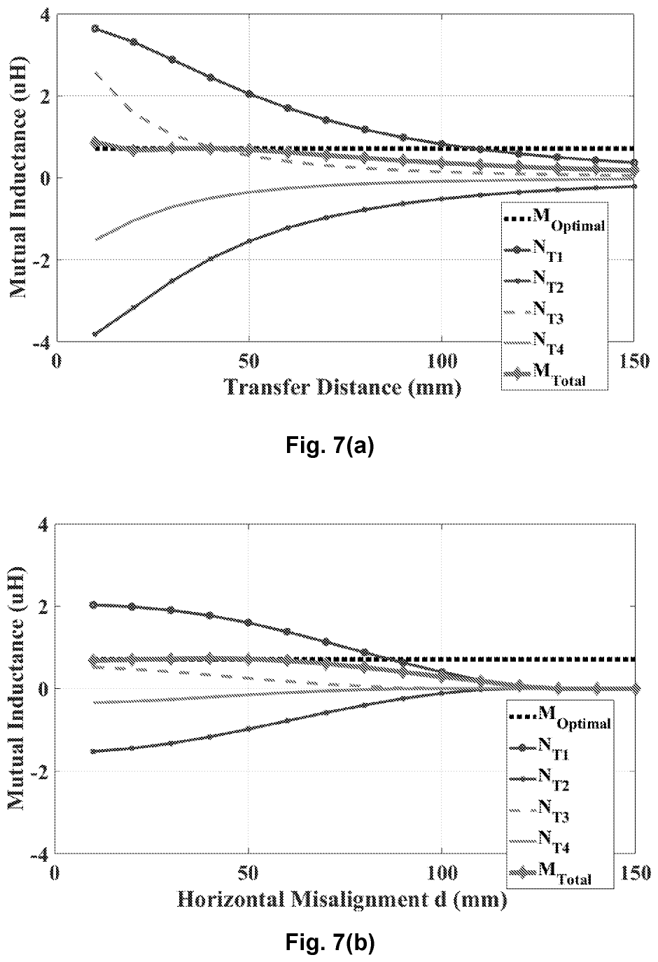

The anti-misalignment feature of according to an exemplary embodiment is optimised at h=50 mm. The mutual inductance between the Rx and each sub-coil in Tx, and total mutual inductance of the system against the transfer distance and horizontal misalignment are calculated using Equations 9 and 14, respectively. The calculated results are shown in FIG. 7. For both the transfer distance varying from 10 mm to 50 mm and the misalignment varying from 0 mm to 50 mm, the total mutual inductances are very constant against the transfer position variation and close to the optimal value. This validates the design method. A high-efficiency range-adaptive CMR-WPT system can be realised.

Transmitter

The transmitter is for inductive charging of the device comprising the receiver. That is, power is transferred from the transmitter to the receiver, in use, by inductive coupling therebetween. That is, the WPT is a near-field technique. In one example, the transmitter is an inductively coupled resonator, for example comprising a capacitor. Inductively coupled resonators are known. In one example, the receiver is an inductively coupled resonator. In one example, the transmitter and the receiver are inductively coupled resonators.

The transmitter comprises the set of coils, preferably planar coils, including the first coil and optionally the second coil, comprising the first turn and the second turn. It should be understood that respective coils of the set of coils comprise respective turns, for example 1 or more turns, including fractional numbers of turns. It should be understood that respective coils of the set of coils comprise continuous electrical conductors, such as wires, ribbons and/or tracks, which provide and/or are arranged as the respective turns. In one example, the set of coils is a set of planar coils, wherein the turns thereof (for example, the first turn and the second turn) are arranged in a plane, for example mutually parallel or substantially mutually parallel planes, preferably the same or substantially the same plane. In one example, the set of coils are coplanar.

The first turn and the second turn are adjacent. That is, the first turn is next to the second turn while spaced apart therefrom, for example by an electrical insulator. In one example, the first turn and the second turn are mutually spaced apart by a first spacing, preferably a substantially constant first spacing, for example in a range from 0.01 w to 100 w, preferably in a range from 0.1 w to 10 w, more preferably in a range from 0.2 w to 5 w, wherein w is a width of the first turn and/or the second turn. The width w of the first turn and/or the second turn is measured orthogonally to the first sense and/or the second sense, respectively. In one example, the first spacing is greater than or equal to the width w of the first set of turns and/or the second set of turns.

In one example, the first turn and/or the second turn has a width w in a range from 0.1 mm to 30 mm.

The first turn has the first sense and the second turn has the second sense, opposed to the first sense. That is, the first turn and the second turn are bi-directional. In one example, the first sense and the second sense are generally circular, for example around an ellipse or a polygon. In one example, the first sense is clockwise and the second sense is anticlockwise. In one example, the first sense is anticlockwise and the second sense is clockwise. In one example, the first sense and the second sense are linear, for example in opposite directions.

In use, current flows through the first turn and the second turn in opposed senses. That is, in use, current flows through the first turn in the first sense and through the second turn in the second sense.

It should be understood that the set of coils comprises the first turn and the second turn. In one example, the first coil comprises the first turn and the second turn. That is, the second turn may be described as looping back on the first turn, such that the first sense and the second sense are opposed. In one example, the first coil comprises the first turn and the second coil comprises the second turn. It should be understood that respective coils of the set of coils may be mutually electrically coupled and/or mutually electrically isolated. In one example, the first coil and the second coil are mutually electrically coupled. In one example, the first coil and the second coil are mutually electrically isolated.

In one example, the first coil comprises T sets of turns (also known as sub-coils) including a first set of turns, including the first turn, and optionally a second set of turns, including the second turn. That is, turns of the first coil may be logically arranged into groups (i.e. the T sets of turns), each group having a particular sense, as defined by the first turn and the second turn. In one example, T is a natural number greater than or equal to 1, for example 1, 2, 3, 4, 5, 6, 7, 8, 9, 10 or more. In one example, T is a natural even number greater than or equal to 2, for example 2, 4, 6, 8, 10 or more. In one example, adjacent sets of turns have opposed senses. In one preferred example, T is a natural even number greater than or equal to 2, for example 2, 4, 6, 8, 10 or more, and adjacent sets of turns have opposed senses.

With sub-coils of opposed senses, the total coupling between the Tx and the Rx will be the difference of the coupling between the sub-coils in the Tx of one sense and the Rx from the coupling between the sub-coils in the Tx of the other sense and the Rx. By maintaining a relatively constant difference, the total coupling can be kept stable under misaligned conditions.

In one example, the first set of turns and the second set of turns are mutually spaced apart by a second spacing, preferably a substantially constant second spacing, 0.01 W to 100 W, preferably in a range from 0.1 W to 10 W, more preferably in a range from 0.2 W to 5 W, wherein W is a width of the first set of turns and/or the second set of turns. The width W of the first set of turns and/or the second set of turns is measured orthogonally to the first sense and/or the second sense, respectively. In one example, the width W of the first set of turns and/or the second set of turns is greater than the width w of the first turn and/or the second turn. In one example, the second spacing is greater than or equal to the width W of the first set of turns and/or the second set of turns.

In one example, the first set of turns includes N turns, including the first turn, wherein N is a natural number greater than or equal to 1 or a fractional number. By increasing the number of turns in the first set of turns, mutual inductance between the transmitter and the receiver may be increased. In one example, the second set of turns includes M turns, including the second turn, wherein M is a natural number greater than or equal to 1 or a fractional number.

In one example, respective turns of the first set of turns have the first sense. In one example, respective turns of the second set of turns have the second sense. That is, more than one turn may have the same sense, not withstanding that the adjacent first turn and the second turn have opposed senses.

In one example, the set of coils consists of the first coil. That is, the set of coils includes only one (i.e. a single) coil. In this way, a complexity of the transmitter is reduced.

In one example, a first dimension, for example a diameter, of the first turn is greater than a second dimension, for example a diameter, of the second turn. The first dimension is a maximum dimension of the first turn through a centre thereof. The second dimension is a maximum dimension of the second turn through a centre thereof.

In one example, the first turn and/or the second turn has substantially a shape selected from: an ellipse for example a circle, a polygon, preferably a regular polygon, for example having P sides, where P is a natural number greater than or equal to 3, for example a triangle, a square, a rectangle, a rhombus, a trapezium, a parallelogram, a kite, a pentagon, a hexagon, a heptagon, an octagon, a nonagon or a decagon. In one example, the first turn and/or the second turn comprises one or more arcuate portions and/or one or more linear portions. Preferably, the first turn and/or the second turn is substantially circular, such as a part of a helix.

In one example, the first turn and the second turn are substantially concentric. That is, respective centres of the first turn and the second turn are substantially coincident.

In one example, the first turn and/or the second turn is substantially spiral, preferably helical. That is, a dimension, for example a diameter, of the first turn and/or the second turn increases or decreases in the first sense and/or the second sense.

Preferred Transmitter

In one preferred example, the transmitter is for inductive charging of the device comprising the receiver, wherein the transmitter comprises:

the set of coils, including the first coil, comprising the first turn and the second turn;

wherein the first turn and the second turn are adjacent; and

wherein the first turn has the first sense and the second turn has the second sense, opposed to the first sense;

whereby, in use, current flows through the first turn and the second turn in opposed senses;

wherein the transmitter and the receiver are inductively coupled resonators;

wherein the set of coils is a set of planar coils;

wherein the first turn and the second turn are mutually spaced apart by a substantially constant first spacing, for example in a range from 0.01 w to 100 w, preferably in a range from 0.1 w to 10 w, more preferably in a range from 0.2 w to 5 w, wherein w is a width of the first turn and/or the second turn, and wherein the first spacing is greater than or equal to the width w of the first set of turns and/or the second set of turns;

wherein the first sense and the second sense are generally circular;

wherein the first sense is clockwise and the second sense is anticlockwise;

wherein the first coil comprises the first turn and the second turn;

wherein the first coil comprises T sets of turns including a first set of turns, including the first turn, and a second set of turns, including the second turn;

wherein T is a natural even number greater than or equal to 2, for example 2, 4, 6, 8, 10 or more;

wherein adjacent sets of turns have opposed senses;

wherein the first set of turns and the second set of turns are mutually spaced apart by a substantially constant second spacing, for example in a range from 0.01 W to 100 W, preferably in a range from 0.1 W to 10 W, more preferably in a range from 0.2 W to 5 W, wherein W is a width of the first set of turns and/or the second set of turns;

wherein the first set of turns includes N turns, including the first turn, wherein N is a natural number greater than or equal to 1 or a fractional number;

wherein the second set of turns includes M turns, including the second turn, wherein M is a natural number greater than or equal to 1 or a fractional number;

wherein respective turns of the first set of turns have the first sense;

wherein respective turns of the second set of turns have the second sense;

wherein the set of coils consists of the first coil;

wherein a first dimension, for example a diameter, of the first turn is greater than a second dimension, for example a diameter, of the second turn;

wherein the first turn and the second turn are substantially circular, such as a part of a helix;

wherein the first turn and the second turn are substantially concentric; and

wherein the first turn and the second turn are substantially helical.

Array

The second aspect provides an array, preferably a planar array, comprising a set of transmitters, including a first transmitter according the first aspect.

In one example, set of transmitters includes T transmitters, wherein T is a natural number greater than or equal to 1, for example 1, 2, 3, 4, 5, 6, 7, 8, 9, 10 or more. In this way, a relatively larger transmitter, for example having a relatively larger area, may be provided.

Network

The third aspect provides a network comprising a transmitter according to the first aspect and a receiver comprising a coil, preferably wherein the transmitter and the receiver are inductively coupled resonators.

In one example, the coil of the receiver is a conventional coil, comprising one or more turns.

Method

The fourth aspect provides a method of inductive charging of a device comprising a receiver using a transmitter according to the first aspect.

More generally, the fourth aspect provides a method of wireless power transfer to a device comprising a receiver using a transmitter according to the first aspect.

In one example, the method comprises resonant inductive charging.

In one example, a resonant frequency is in a range from 1 kHz to 1 GHz, preferably in a range from 100 kHz to 100 MHz, more preferably in a range from 1 MHz to 50 MHz, for example 10 MHz.

In one example, the method comprises changing a transfer distance and/or a horizontal misalignment between the transmitter and the receiver, wherein a mutual inductance therebetween is substantial constant, for example wherein the transfer distance is increased or decreased by at least 25%, preferably at least 50%, more preferably at least 75%, most preferably at least 100% and/or wherein the horizontal misalignment is at least at least 25%, preferably at least 50%, more preferably at least 75%, most preferably at least 100% of a dimension of the transmitter and/or the receiver.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

Implementation and Measurements

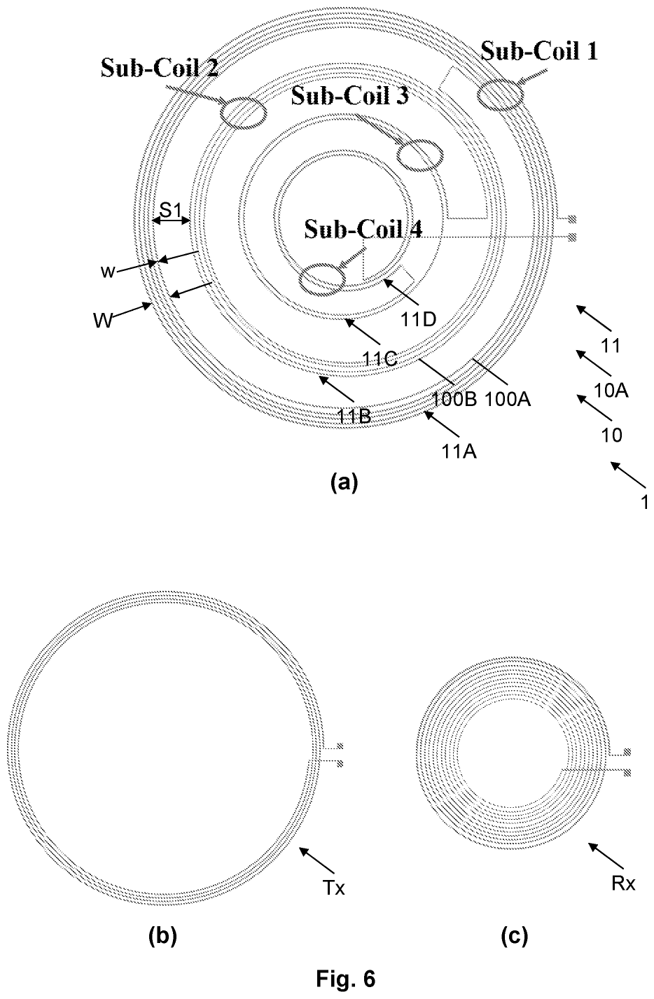

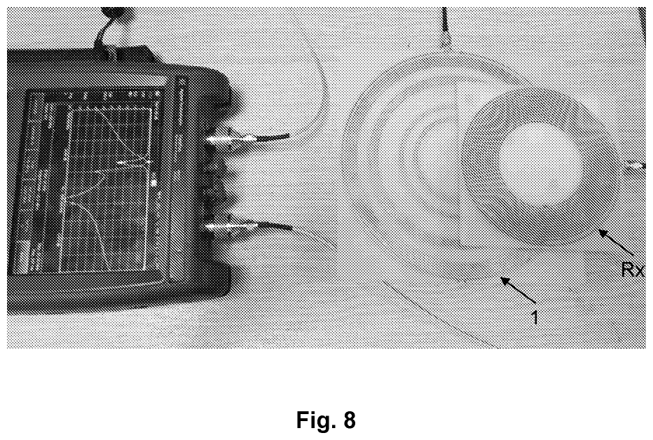

To validate a CMR-WPT structure according to an exemplary embodiment and the design method, a prototype has been fabricated on an FR4 substrate with parameters listed in Table 1. The exemplary Tx 1 and Rx structures are shown in FIGS. 6(a) and 6(c) respectively. Furthermore, two conventional unidirectional CMR-WPT systems have been built, namely, Type I and Type II with parameters shown in Table 1, for comparison. Type I uses a Tx with an identical structure to the Rx. Type II uses a Tx with the same size as the exemplary embodiment but without using bi-directional sub-coils as shown in FIG. 6(b). All three systems use a Rx of the same size. The windings of the three Rx are different due to that the resonant conditions are different. The port terminations of the WPT systems were chosen to be 50Ω for simplicity. A vector network analyser (VNA) and 50Ω cables were used for the measurement. The S₂₁ performance is evaluated by the two-port 50Ω VNA. A photograph of the measurement set-up is shown FIG. 8.

Particularly, the exemplary transmitter 1 of FIG. 6(a) is for inductive charging of a device D comprising a receiver R, wherein the transmitter 1 comprises:

a set of coils 10, including a first coil 10A, comprising a first turn 100A and a second turn 100B;

wherein the first turn 100A and the second turn 100B are adjacent; and

wherein the first turn 100A has the first sense and the second turn 100B has the second sense, opposed to the first sense;

whereby, in use, current flows through the first turn 100A and the second turn 100B in opposed senses.

In more detail, the transmitter 1 is for inductive charging of the device D comprising the receiver R, wherein the transmitter 1 comprises:

the set of coils 10, including the first coil 10A, comprising the first turn 100A and the second turn 100B;

wherein the first turn 100A and the second turn 100B are adjacent; and

wherein the first turn 100A has the first sense and the second turn 100B has the second sense, opposed to the first sense;

whereby, in use, current flows through the first turn 100A and the second turn 100B in opposed senses;

wherein the transmitter 1 and the receiver R are inductively coupled resonators;

wherein the set of coils 10 is a set of planar coils;

wherein the first turn 100A and the second turn 100B are mutually spaced apart by a substantially constant first spacing S1, for example in a range from 0.01 w to 100 w, preferably in a range from 0.1 w to 10 w, more preferably in a range from 0.2 w to 5 w, wherein w is a width of the first turn and/or the second turn, and wherein the first spacing is greater than or equal to the width w of the first set of turns and/or the second set of turns;

wherein the first sense and the second sense are generally circular;

wherein the first sense is clockwise and the second sense is anticlockwise;

wherein the first coil 10A comprises the first turn 100A and the second turn 100B;

wherein the first coil 10A comprises 4 sets of turns 11 including a first set of turns 11A, including 5.2 turns including the first turn 100A, a second set of turns 11B, including 4.2 turns including the second turn 100B, a third set of turns 11C including 1.8 turns and a fourth set of turns 11D including 2.2 turns;

wherein T is a natural even number equal to 4;

wherein adjacent sets of turns 11A, 11B, 11C, 11D have opposed senses;

wherein the first set of turns 11A and the second set of turns 11B are mutually spaced apart by a substantially constant second spacing, for example in a range from 0.01 W to 100 W, preferably in a range from 0.1 W to 10 W, more preferably in a range from 0.2 W to 5 W, wherein W is a width of the first set of turns 11A and/or the second set of turns 11B;

wherein the first set of turns 11A includes 5.2 turns, including the first turn 100A;

wherein the second set of turns 11B includes 4.2 turns, including the second turn 100B;

wherein respective turns of the first set of turns 11A have the first sense;

wherein respective turns of the second set of turns 11B have the second sense;

wherein the set of coils 10 consists of the first coil 10A;

wherein a first dimension, for example a diameter, of the first turn 100A is greater than a second dimension, for example a diameter, of the second turn 100B;

wherein the first turn 100A and the second turn 100B are substantially circular, such as a part of a helix;

wherein the first turn 100A and the second turn 100B are substantially concentric; and

wherein the first turn 100A and the second turn 100B are substantially helical.

Refer also to Table 1 for dimensions of the transmitter 1.

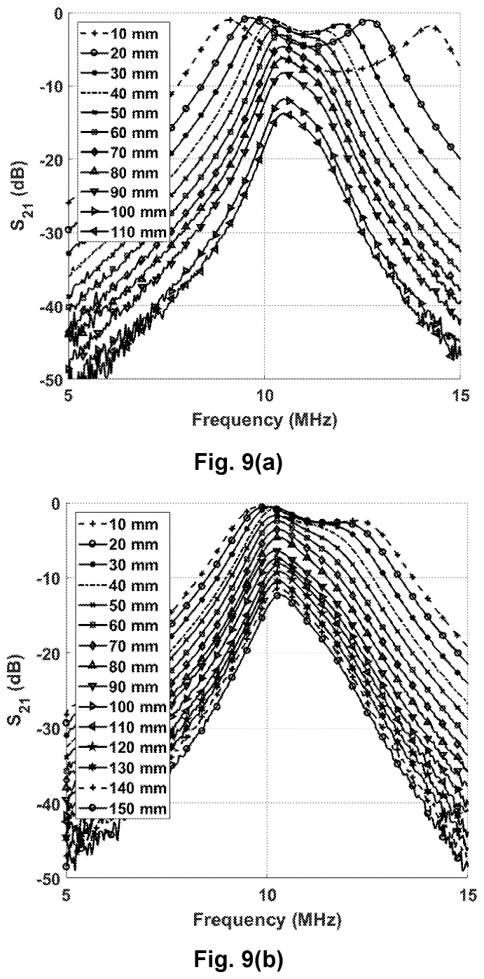

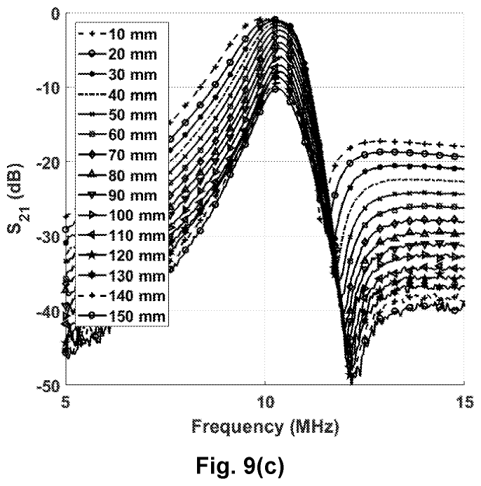

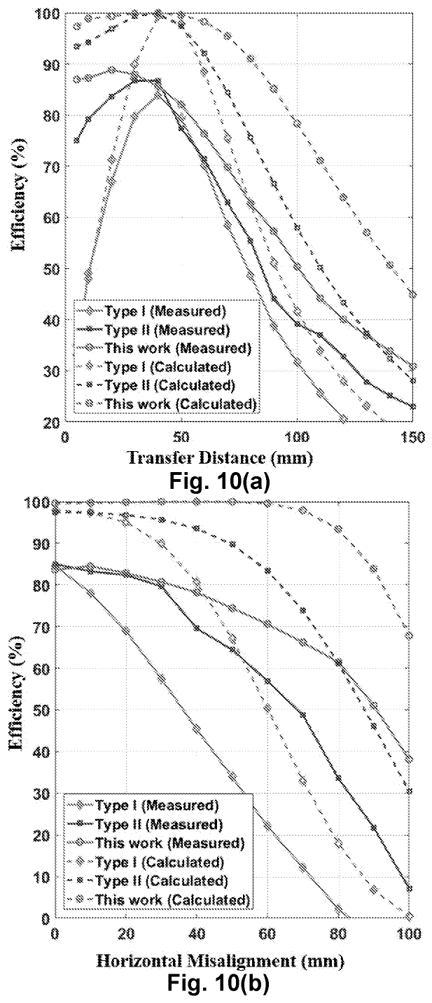

The measured S₂₁ (dB) of the exemplary embodiment and the conventional systems are presented in FIG. 9. The value of h is varied from 10 mm to 150 mm (10-110 mm for Type-I due to that S₂₁ is too small with a larger distance). The exemplary embodiment shows the capability of avoiding the frequency splitting phenomena while the conventional designs have shifted resonant frequencies at shorter transfer distances. The measured S₂₁ at the desired resonant frequency (10.3 MHz herein) against the transfer distance (without misalignment d=0 mm) is depicted in FIG. 10(a). The conventional designs were able to achieve the maximum S₂₁ only at h=40 mm. The S₂, drops fast when the transfer distance deviates from the optimum one. The exemplary embodiment has a significantly improved efficiency with both shorter and longer transfer distances. The S₂₁ of the exemplary embodiment has a much slower degradation slope compared to the conventional designs. The exemplary embodiment achieved a S₂₁ better than 70% with a transfer distance varying from 0 mm to 70 mm, or better than 40% with the transfer distance changing from 0 mm to 130 mm. The results validate that the exemplary embodiment is robust against the transfer distance variation.

The measured PTE at the desired resonant frequency against the d varying from 0 mm to 100 mm is depicted in FIG. 10(b). Here h=40 mm was chosen because Type I and Type II designs can achieve the highest PTE at this transfer distance. The measured PTE of the Type I design drops rapidly. The Type II system can maintain a slightly slower degradation when d is smaller than 30 mm. Once d is comparable to the radius of the Rx, the deterioration of the Type II PTE is dramatic. The exemplary embodiment achieves a much slower PTE decrease against d compared with the conventional systems. The exemplary embodiment can maintain a PTE better than 40% with the misalignment changing from 0 mm to 100 mm. The results prove that the exemplary embodiment has a better robustness to the horizontal misalignment compared with Type I and II systems. Although, the highest PTE has not been improved by the exemplary embodiment compared with the other circuits, the PTE degradation has been significantly improved.

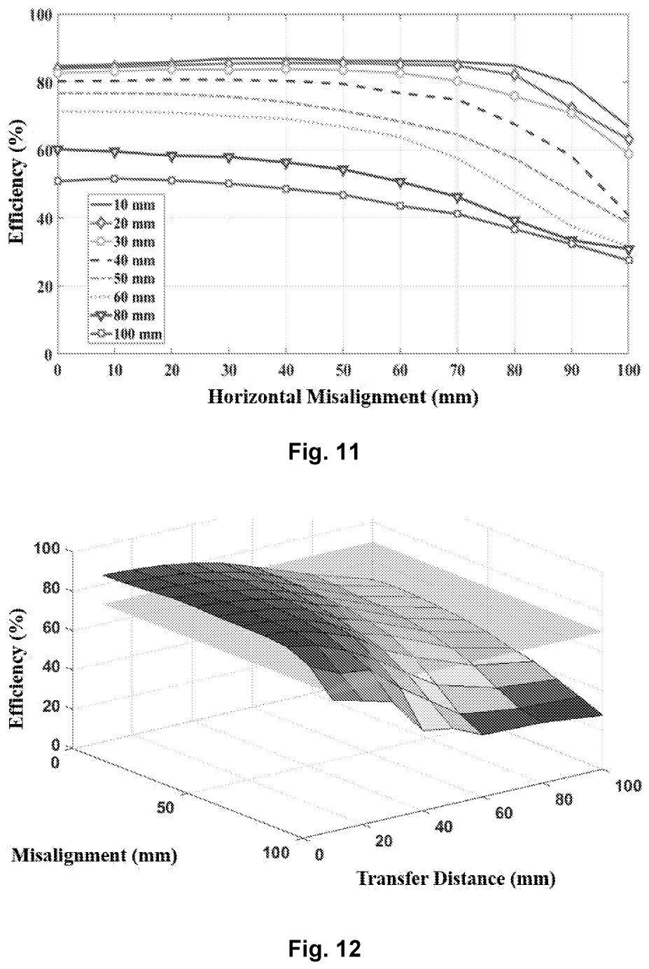

Further investigation was carried out to demonstrate the anti-misalignment ability of the proposed system with other transfer distances. The measured PTE of the exemplary embodiment against both the transfer distance and misalignment are plotted in FIG. 11. When the transfer distance is smaller than 40 mm, the PTE can be maintained above 70% with the misalignment varying from 0 mm to 70 mm. Although the anti-misalignment ability will not be as good when the transfer distance further increases, the PTE has been kept better than 30% with a misalignment of 100 mm at the distance of 100 mm as shown in FIG. 11. The performance of the exemplary embodiment against the transfer position variation is shown in FIG. 12 with a 70% S₂₁ reference plane. The exemplary embodiment has achieved a PTE better than 70% with transfer distances from 0 mm to 50 mm and misalignment from 0 mm to 50 mm. The measured results show a great potential of the exemplary embodiment in applications where the flexibility of transfer position and a high efficiency are critical.

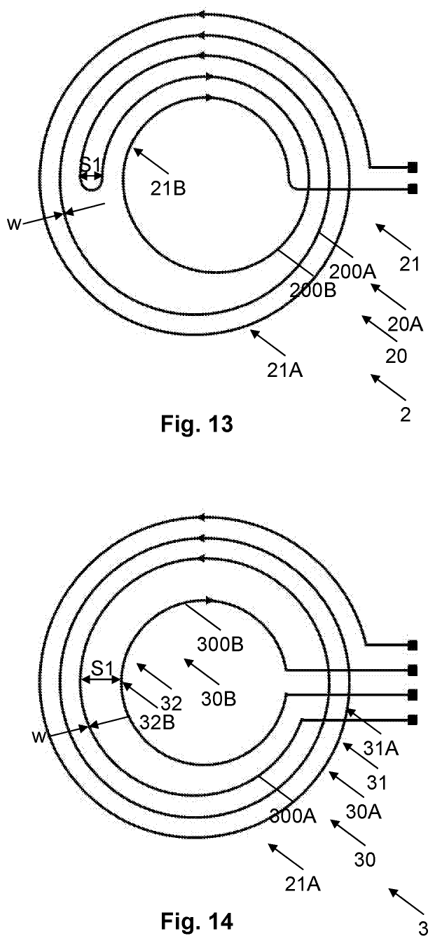

FIG. 13 shows a transmitter 2 according to an exemplary embodiment.

Particularly, the exemplary transmitter 2 of FIG. 13 is for inductive charging of a device D comprising a receiver R, wherein the transmitter 2 comprises:

a set of coils 20, including a first coil 20A, comprising a first turn 200A and a second turn 200B;

wherein the first turn 200A and the second turn 200B are adjacent; and

wherein the first turn 200A has the first sense and the second turn 200B has the second sense, opposed to the first sense;

whereby, in use, current flows through the first turn 200A and the second turn 200B in opposed senses.

In more detail, the transmitter 2 is for inductive charging of the device D comprising the receiver R, wherein the transmitter 2 comprises:

the set of coils 20, including the first coil 20A, comprising the first turn 200A and the second turn 200B;

wherein the first turn 200A and the second turn 200B are adjacent; and

wherein the first turn 200A has the first sense and the second turn 200B has the second sense, opposed to the first sense;

whereby, in use, current flows through the first turn 200A and the second turn 200B in opposed senses;

wherein the transmitter 2 and the receiver R are inductively coupled resonators;

wherein the set of coils 20 is a set of planar coils;

wherein the first turn 200A and the second turn 200B are mutually spaced apart by a substantially constant first spacing S1, for example in a range from 0.01 w to 100 w, preferably in a range from 0.1 w to 10 w, more preferably in a range from 0.2 w to 5 w, wherein w is a width of the first turn and/or the second turn, and wherein the first spacing is greater than or equal to the width w of the first set of turns and/or the second set of turns;

wherein the first sense and the second sense are generally circular;

wherein the first sense is anticlockwise and the second sense is clockwise;

wherein the first coil 20A comprises the first turn 200A and the second turn 200B;

wherein the first coil 20A comprises 2 sets of turns 21 including a first set of turns 21A, including about 1 turn including the first turn 200A and a second set of turns 21B, including about 1 turn including the second turn 200B;

wherein T is a natural even number equal to 2;

wherein adjacent sets of turns 21A, 21B have opposed senses;

wherein the first set of turns 21A and the second set of turns 21B are mutually spaced apart by a substantially constant second spacing, for example in a range from 0.01 W to 100 W, preferably in a range from 0.1 W to 10 W, more preferably in a range from 0.2 W to 5 W, wherein W is a width of the first set of turns 21A and/or the second set of turns 21B;

wherein the first set of turns 21A includes about 2.5 turns, including the first turn 200A;

wherein the second set of turns 21B includes about 1.5 turns, including the second turn 200B;

wherein respective turns of the first set of turns 21A have the first sense;

wherein respective turns of the second set of turns 21B have the second sense;

wherein the set of coils 20 consists of the first coil 20A;

wherein a first dimension, for example a diameter, of the first turn 200A is greater than a second dimension, for example a diameter, of the second turn 200B;

wherein the first turn 200A and the second turn 200B are circular; and

wherein the first turn 200A and the second turn 200B are concentric.

FIG. 14 shows a transmitter 3 according to an exemplary embodiment.

Particularly, the exemplary transmitter 3 of FIG. 14 is for inductive charging of a device D comprising a receiver R, wherein the transmitter 3 comprises:

a set of coils 30, including a first coil 30A and a second coil 30B, comprising a first turn 300A and a second turn 300B;

wherein the first turn 300A and the second turn 300B are adjacent; and

wherein the first turn 300A has the first sense and the second turn 300B has the second sense, opposed to the first sense;

whereby, in use, current flows through the first turn 300A and the second turn 300B in opposed senses.

In more detail, the transmitter 3 is for inductive charging of the device D comprising the receiver R, wherein the transmitter 3 comprises:

the set of coils 30, including the first coil 30A and the second coil 30B, comprising the first turn 300A and the second turn 300B;

wherein the first turn 300A and the second turn 300B are adjacent; and

wherein the first turn 300A has the first sense and the second turn 300B has the second sense, opposed to the first sense;

whereby, in use, current flows through the first turn 300A and the second turn 300B in opposed senses;

wherein the transmitter 3 and the receiver R are inductively coupled resonators;

wherein the set of coils 30 is a set of planar coils;

wherein the first turn 300A and the second turn 300B are mutually spaced apart by a substantially constant first spacing S1, for example in a range from 0.01 w to 100 w, preferably in a range from 01 w to 10 w, more preferably in a range from 0.2 w to 5 w, wherein w is a width of the first turn and/or the second turn, and wherein the first spacing is greater than or equal to the width w of the first set of turns and/or the second set of turns;

wherein the first sense and the second sense are generally circular;

wherein the first sense is anticlockwise and the second sense is clockwise;

wherein the first coil 30A comprises the first turn 300A;

wherein the second coil 30B comprises the second turn 300B;

wherein the first coil 30A comprises 1 set of turns 31 including a first set of turns 31A, including about 1 turn including the first turn 300A;

wherein the second coil 30B comprises 1 set of turns 32 including a second set of turns 32B, including about 1 turn including the second turn 300B;

wherein the first set of turns 31A includes about 3 turns, including the first turn 300A;

wherein the second set of turns 32B includes about 1 turn, including the second turn 300B;

wherein respective turns of the first set of turns 31A have the first sense;

wherein respective turns of the second set of turns 32B have the second sense;

wherein the set of coils 30 consists of the first coil 30A and the second coil 30B;

wherein a first dimension, for example a diameter, of the first turn 300A is greater than a second dimension, for example a diameter, of the second turn 300B;

wherein the first turn 300A and the second turn 300B are circular; and

wherein the first turn 300A and the second turn 300B are concentric.

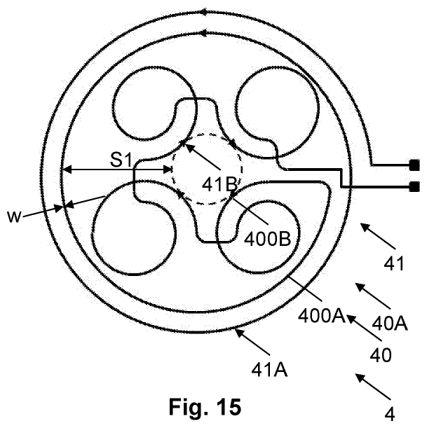

FIG. 15 shows a transmitter 4 according to an exemplary embodiment.

Particularly, the exemplary transmitter 4 of FIG. 15 is for inductive charging of a device D comprising a receiver R, wherein the transmitter 4 comprises:

a set of coils 40, including a first coil 40A, comprising a first turn 400A and a second turn 400B;

wherein the first turn 400A and the second turn 400B are adjacent; and

wherein the first turn 400A has the first sense and the second turn 400B has the second sense, opposed to the first sense;

whereby, in use, current flows through the first turn 400A and the second turn 400B in opposed senses.

In more detail, the transmitter 4 is for inductive charging of the device D comprising the receiver R, wherein the transmitter 4 comprises:

the set of coils 40, including the first coil 40A, comprising the first turn 400A and the second turn 400B;

wherein the first turn 400A and the second turn 400B are adjacent; and

wherein the first turn 400A has the first sense and the second turn 400B has the second sense, opposed to the first sense;

whereby, in use, current flows through the first turn 400A and the second turn 400B in opposed senses;

wherein the transmitter 4 and the receiver R are inductively coupled resonators;

wherein the set of coils 40 is a set of planar coils;

wherein the first turn 400A and the second turn 400B are mutually spaced apart by a substantially constant first spacing S1, for example in a range from 0.01 w to 100 w, preferably in a range from 0.1 w to 10 w, more preferably in a range from 0.2 w to 5 w, wherein w is a width of the first turn and/or the second turn, and wherein the first spacing is greater than or equal to the width w of the first set of turns and/or the second set of turns;

wherein the first sense and the second sense are generally circular;

wherein the first sense is anticlockwise and the second sense is clockwise;

wherein the first coil 40A comprises the first turn 400A and the second turn 400B;

wherein the first coil 40A comprises 4 sets of turns 41 including a first set of turns 41A, including about 1 turn including the first turn 400A and a second set of turns 41B, including about 1 turn including the second turn 400B;

wherein T is a natural even number equal to 4;

wherein adjacent sets of turns 41A, 41B have opposed senses;

wherein the first set of turns 41A and the second set of turns 41B are mutually spaced apart by a substantially constant second spacing, for example in a range from 0.01 W to 100 W, preferably in a range from 0.1 W to 10 W, more preferably in a range from 0.2 W to 5 W, wherein W is a width of the first set of turns 41A and/or the second set of turns 41B;

wherein the first set of turns 41A includes about 2 relatively larger turns, including the first turn 400A, and 4 relatively smaller turns;

wherein the second set of turns 41B includes about 1 turn, including the second turn 400B;

wherein respective turns of the first set of turns 41A have the first sense;

wherein respective turns of the second set of turns 41B have the second sense;

wherein the set of coils 40 consists of the first coil 40A;

wherein a first dimension, for example a diameter, of the first turn 400A is greater than a second dimension, for example a diameter, of the second turn 400B;

wherein the first turn 400A and the second turn 400B are circular; and

wherein the first turn 400A and the second turn 400B are concentric.

In contrast to the transmitter 2, the second turn 400B of the transmitter 4 is provided by interconnecting portions of four the four relatively smaller turns arranged approximately in a square.

Although a preferred embodiment has been shown and described, it will be appreciated by those skilled in the art that various changes and modifications might be made without departing from the scope of the invention, as defined in the appended claims and as described above.

WPT systems using magnetic couplings are usually susceptible to transfer position variation due to that the coupling condition between the transmitting and receiving coils is highly position-dependent. Once the transfer position deviates from the optimum one, the coupling will be either excessive or weak which results in transfer efficiency degradation. This paper presents the design of a transmitter structure consisting of multiple sub-coils oriented in opposite directions. The coupling is kept relatively constant over an extensive range of transfer positions. A prototype according to an exemplary embodiment is able to achieve a PTE of 88%-70% with the transfer distance varying from 5 mm to 70 mm and a PTE of 85%-60% with the misalignment changing from 0 mm-80 mm at a 40 mm transfer distance. The diameters of the transmitter and receiver are 84.6 mm and 45.1 mm respectively. The measured PTE of the exemplary embodiment can be kept better than 70% with a transfer distance varying from 5 mm to 50 mm and the misalignment from 0 mm to 50 mm. One suitable application is the wireless charging or portable devices such as smartphones. Due to that the system is robust against the transfer position variation between the transmitter and receiver, it will enable high efficiency charging while the device is being used, as long as the phone is near to the transmitter. Furthermore, the structure can be scaled up/down for other applications such as the wireless charging of drones, electrical vehicles, wearable devices and implantable devices.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A transmitter for inductive charging of a device comprising a receiver, wherein the transmitter comprises:
a set of coils including a first coil and optionally a second coil, comprising a first turn and a second turn;
wherein the first turn and the second turn are adjacent; and
wherein the first turn has a first sense and the second turn has a second sense, opposed to the first sense;
whereby, in use, current flows through the first turn and the second turn in opposed senses.

2. The transmitter according to claim 1, wherein the first coil comprises the first turn and the second turn.

3. The transmitter according to claim 1, wherein the first coil comprises T sets of turns including a first set of turns, including the first turn, and optionally a second set of turns, including the second turn.

4. The transmitter according to claim 3, wherein the first set of turns includes N turns, including the first turn, wherein N is a natural number greater than or equal to 1 or a fractional number.

5. The transmitter according to claim 4, wherein respective turns of the first set of turns have the first sense.

6. The transmitter according to claim 1, wherein the first sense is clockwise and the second sense is anticlockwise.

7. The transmitter according to claim 1, wherein a first dimension of the first turn is greater than a second dimension of the second turn.

8. The transmitter according to claim 1, wherein the first turn has substantially a shape selected from: an ellipse for example a circle, a polygon; having P sides, where P is a natural number greater than or equal to 3.

9. The transmitter according to claim 1, wherein the first turn and the second turn are substantially concentric.

10. The transmitter according to claim 1, wherein the first turn is substantially spiral.

11. The transmitter according to claim 1, wherein the first turn and the second turn are mutually spaced apart by a first spacing in a range from 0.01 w to 100 w, wherein w is a width of the first turn and/or the second turn.

12. The transmitter according to claim 1, wherein the first turn has a width w in a range from 0.1 mm to 30 mm.

13. An array comprising a set of transmitters, including a first transmitter according to claim 1.

14. A network comprising a transmitter according to claim 1; and a receiver comprising a coil.

15. A method of inductive charging of a device comprising a receiver using a transmitter according to claim 1.
